(19) United States
(12) Patent Application Publication
(10) Pub. No.: US 2022/0024243 A1
(43) Pub. Date: Jan. 27, 2022

(54) PLASTIC PRODUCT CONTAINING LUMINESCENT MATERIAL AND METHOD FOR DETERMINING AUTHENTICITY OF SAME

(71) Applicant: KOREA MINTING, SECURITY PRINTING & ID CARD OPERATING CORP., Daejeon (KR)

(72) Inventors: Sung Hyun JOO, Sejong (KR); Il Hoon CHOI, Daejeon (KR); Hyun Jun KIM, Daejeon (KR); Hyun Jin OH, Daejeon (KR); Se Hyun LEE, Sejong (KR); Yang Jae LEE, Daejeon (KR)

(21) Appl. No.: 17/294,857

(22) PCT Filed: Jan. 10, 2019
(86) PCT No.: PCT/KR2019/000390

§ 371 Date: May 18, 2021

(51) Int. Cl. B42D 25/382; B42D 25/21; G01N 21/64; C09K 11/08; C08K 3/013

(52) U.S. Cl. CPC B42D 25/382; B42D 25/21; C08K 2201/005; C09K 11/08; C08K 3/013; G01N 21/6408

(57) ABSTRACT

Disclosed is a plastic product with authenticity to be determined, the plastic product including: a base made of a plastic material, and a luminescent material included in the base and configured to emit light including a second wavelength with respect to incident light including a first wavelength, in which the determination of the authenticity is performed by irradiating the plastic product with the incident light and then detecting the emitted light. According to the present invention, it is possible to easily determine the authenticity of the plastic product by a simple method of detecting a spectrum of the light emitted from the plastic product.

### CROSS-REFERENCE TO RELATED APPLICATION

This application is a U.S. national phase application of PCT International Application PCT/KR2019/000390, filed Jan. 10, 2019, which claims priority to Korean Patent Application No. 2018-0147771 filed with the Korean Intellectual Property Office on Nov. 26, 2018, the entire contents of which are herein incorporated by reference.

### TECHNICAL FIELD

The present invention relates to a plastic product, the authenticity of which can be easily determined, and a method of determining authenticity of the plastic product.

### BACKGROUND ART

Plastic materials are light in weight and excellent in mechanical characteristics and processability, and thus the plastic materials are used for various products such as vehicle components, aircraft components, electronic products, building materials, and containers for general consumer goods, cosmetics, medicines, food, and drink. Recently, however, there is an increasing number of counterfeit plastic products manufactured using unauthorized materials. After the plastic product is molded, processed, or manufactured as a final product, it is difficult to determine whether the plastic product is a genuine product made of an authorized material. In a case in which the plastic product is manufactured by applying an alternative cheap material to a part of an overall volume of the plastic product, it is practically impossible to determine the authenticity of the plastic product.

In particular, engineering plastic, which is excellent in mechanical strength and heat resistance and expensive, is widely used for various industrial products such as electronic products, structural materials for vehicles and aircrafts, and building materials including exterior materials for buildings. Because the engineering plastic is expensive, there is an increasing number of counterfeit engineering plastic products.

In addition, problems of counterfeit plastic containers for accommodating cosmetics, medicines, food, drink, and the like are recognized seriously in relation to authenticity of contents accommodated in the container.

Korean Patent Nos. 1203199 and 1697224 disclose technologies for providing security to plastic products. Korean Patent No. 1203199 discloses the technology for manufacturing a plastic product containing a stereoscopic security element including a micro-lens array and a micro-image array through an in-mold injection process. Korean Patent No. 1697224 discloses the technology for combining a stereoscopic panel with a lid of a cosmetic container so that a stereoscopic image is observed from the outside.

Because all the technologies are provided to allow consumers to identify the authenticity by visually observing specific images and depend on the visual effect, there is a limitation in identifying the authenticity. For example, in the case of a counterfeit product having a similar image that a consumer recognizes as an image of a genuine product, it is difficult for the consumer to identify the authenticity only by visually observing the image.

Further, because the consumer easily identifies, with the naked eye, the security element applied to the specific position on the product, it may be relatively easy to attempt to manufacture the counterfeit product.

In addition, because these technologies basically and inevitably affect a visual design of the plastic product, there is a limitation in relation to a range of application.

### DISCLOSURE

### Technical Problem

The present invention has been made in an effort to solve the above-mentioned problems in the related art, and an object of the present invention is to provide a plastic product with security improved by allowing a consumer to determine authenticity using a dedicated device without depending on identification with the naked eye, and a method of determining the authenticity of the plastic product.

Another object of the present invention is to provide a plastic product provided with a security element that is not recognized with the naked eye and thus is relatively difficult to counterfeit, and a method of determining the authenticity of the plastic product.

Still another object of the present invention is to provide a plastic product to which a security function may be provided without affecting a design of the plastic product, and a method of determining the authenticity of the plastic product.

The objects of the present invention are not limited to the above-mentioned objects, and other objects and advantages of the present invention, which are not mentioned above, may be clearly understood from the following descriptions.

### Technical Solution

A plastic product according to one aspect of the present invention is a plastic product with authenticity to be determined and includes: a base made of a plastic material; and a luminescent material included in the base and configured to emit light including a second wavelength with respect to incident light including a first wavelength, in which the determination of the authenticity is performed by irradiating the plastic product with the incident light and then detecting the emitted light.

The second wavelength may be in an infrared wavelength range.

The luminescent material may be at least any one of materials according to the following General Formulas 1 to 6,

General Formula 1: Ba₁₋ₓSnAₓO₃ (0<x<0.4, and A represents Li or Na);

General Formula 2: CaMoO₄:M (M represents one or two or more lanthanide metal ions selected from a group consisting of Nd³⁺, Yb³⁺, and Er³⁺);

General Formula 3: Y₂SiV₂O₁₀: Nd³⁺ and Er³⁺;

General Formula 4: Y₂O₃:Yb and Ho;

General Formula 5: Y₂O₃:Yb and Tm; and

General Formula 6: Y₂O₃:Yb and Er.

The luminescent material may be provided in the form of a particle and included in the base, and an average particle size of the luminescent material may be in a range of 0.3 to 10 μm. A surface of the luminescent material particle may be treated or coated with an organic material.

The base may include a plurality of layers, and the luminescent material may be included only in some of the plurality of layers.

In addition, the base may include a plurality of layers, and the plurality of layers may include different luminescent materials. The different luminescent materials may be different in at least one of excitation light and emitted light.

The plastic product according to the embodiment of the present invention may be manufactured by an injection molding process. In the case in which the base includes a plurality of layers, and the plastic product may be manufactured by a dual injection molding process or a co-injection molding process.

The plastic product according to the embodiment of the present invention may be any one of a plastic container, a casino chip, and an electronic product casing.

The plastic product according to the embodiment of the present invention may be a plastic container including an accommodation part having an accommodation space for accommodating contents, the base constituting the plastic container may include a first base provided inside the plastic container and disposed adjacent to the accommodation space, and a second base provided outside the first base, and the luminescent material may be included only in the second base without being included in the first base.

A plastic product according to another embodiment of the present invention is a plastic product with authenticity to be determined and includes: a base having a surface on which a mark is printed; and a luminescent material included in the mark and configured to emit light including a second wavelength with respect to incident light including a first wavelength, in which the determination of the authenticity is performed by irradiating the mark with the incident light and then detecting the emitted light.

A method of determining authenticity of a plastic product according to another aspect of the present invention is a method of determining authenticity of any one of the above-mentioned plastic products and includes: a step (a) of irradiating the plastic product with the incident light including the first wavelength; a step (b) of detecting the light emitted from the plastic product and including the second wavelength; and a step (c) of determining authenticity using the detected emitted light.

The step (c) may include a step of comparing a preset critical value with a peak value of the second wavelength, a sum of intensity of emitted light in a predetermined wavelength range including the second wavelength (a value made by integrating intensity of the emitted light in a predetermined wavelength range), or a light emitting lifetime of the second wavelength.

An authenticity determination device for determining authenticity of a plastic product according to still another aspect of the present invention is an authenticity determination device for determining authenticity of the above-mentioned plastic product and includes: a light source unit configured to emit the incident light including the first wavelength; an emitted-light determination unit configured to detect the emitted light including the second wavelength; and a verification unit configured to receive a detection result from the emitted-light determination unit and determine the authenticity of the plastic product.

The above-mentioned main technical solutions of the present invention will be described more specifically and clearly with reference to the following specific contents for carrying out the invention and the accompanying drawings. In this case, various technical solutions according to the present invention will be additionally provided and described in addition to the above-mentioned main technical solutions.

### Advantageous Effects

According to the present invention, it is possible to determine the authenticity using the simple method of detecting the optical signal emitted from the plastic product.

In addition, it is possible to determine the authenticity of the plastic product using the dedicated device without depending on the identification with the naked eye.

In addition, it is possible to provide the plastic product provided with the security element that is not recognized with the naked eye and thus is relatively difficult to counterfeit.

In addition, it is possible to provide the plastic product to which the security function may be provided without affecting the design of the plastic product, and the method of determining the authenticity of the plastic product.

However, the effects obtained by the plastic product and the method of determining the authenticity of the plastic product according to the embodiment of the present invention are not limited to the aforementioned effects, and other effects, which are not mentioned above, will be clearly understood by those skilled in the art from the following description.

### DESCRIPTION OF DRAWINGS

The brief description of the drawings is provided to more sufficiently understand the drawings used in the present specification.

FIG. 1 is a view schematically illustrating a plastic product according to an embodiment of the present invention.

FIG. 2 is a flowchart for explaining a method of manufacturing the plastic product according to the embodiment of the present invention.

FIG. 3 is a flowchart for explaining a method of determining authenticity of the plastic product according to the embodiment of the present invention.

FIG. 4 is a schematic block diagram of an authenticity determination device capable of being used to perform the authenticity determination method illustrated in FIG. 3.

FIGS. 5 to 7 are views schematically illustrating plastic products according to other embodiments of the present invention.

### MODE FOR INVENTION

The present invention may be variously changed and may have various embodiments, and specific embodiments illustrated in the drawings will be described in detail. However, the description of the embodiments is not intended to limit the present invention to the particular embodiments, but it should be understood that the present invention is to cover all modifications, equivalents and alternatives falling within the spirit and technical scope of the present invention.

In the description of the present invention, the specific descriptions of publicly known related technologies will be omitted when it is determined that the specific descriptions may unnecessarily obscure the subject matter of the present invention. In addition, the ordinal numbers (e.g., first, second, etc.) used for the description in the present specification are merely identification symbols for distinguishing one component from another component.

In addition, the component, which is expressed by “part” in the present specification, may be made by combining two or more components into a single component or dividing one component into two or more components for each subdivided function. In addition, each of the components to be described below may not only perform a main function thereof, but also additionally perform some or all functions to be performed by other components. Of course, some of the main functions to be performed by each of the components may be performed by other components.

Unless otherwise described in the present specification, the term ‘plastic product’ should be broadly interpreted as meaning a product made of plastic. For example, the ‘product’ may include a finished product, a semi-finished product made by semi-processing a plastic raw material, or some components constituting the finished product.

For example, the semi-finished product made by semi-processing the plastic raw material may be provided in the form of a single-layered or multilayered plastic film or sheet. In the plastic processing field, a film and a sheet are understood as having different thickness ranges, but in the present specification, the film and the sheet will be commonly called the film in order to avoid confusion.

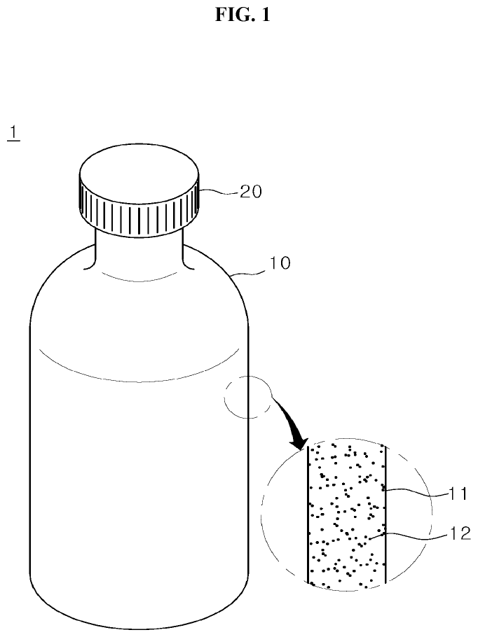

Further, in the present specification, the ‘plastic product’ is not limited to a product entirely made of plastic but should be understood as meaning a product at least partially made of plastic. FIG. 1 is a view schematically illustrating a plastic product 1 according to an embodiment of the present invention. For example, the plastic product 1 may be a plastic container including: an accommodation part 10 configured to accommodate contents such as cosmetics, medicines, food, and drink in an accommodation space therein; and a lid part 20 separably coupled to the accommodation part. However, the plastic product according to the present invention is not limited to the plastic container.

Referring to FIG. 1, the plastic product 1 according to the embodiment of the present invention may include a base 11, and a luminescent material 12 included in the base 11.

The base 11 may be made of a plastic material. The plastic material constituting the base 11 may be, but not particularly limited to, a material including polyethylene terephthalate (PET), polycarbonate (PC), acrylonitrile butadiene styrene (ABS) copolymer, polypropylene (PP), polyethylene (PE), polystyrene (PS), polymethyl methacrylate (PMMA), acrylonitrile styrene (AS) copolymer, polyvinyl chloride (PVC), ethylene-vinyl acetate copolymer (EVA), polyamide (PA), polyester resin (PBT), NORYL resin, or the like.

The base 11 may be made of a material transparent or semi-transparent to a first wavelength and a second wavelength used to determine authenticity in an authenticity determination method to be described below.

The luminescent material 12 is a material for emitting light including the second wavelength when the material is irradiated with incident light including the first wavelength. In this case, various materials may be used in accordance with the first wavelength and the second wavelength. For example, the luminescent material 12 is a material which is not observed with the naked eye in a general visible ray area, and materials defined by the following General Formulas may be used.

General Formula 1: Ba₁₋ₓSnAₓO₃ (0<x<0.4, and A represents Li or Na)

General Formula 2: CaMoO₄:M (M represents one or two or more lanthanide metal ions selected from a group consisting of Nd³⁺, Yb³⁺, and Er³⁺)

General Formula 3: Y₂SiV₂O₁₀: Nd³⁺ and Er³⁺

General Formula 4: Y₂O₃:Yb and Ho

General Formula 5: Y₂O₃:Yb and Tm

General Formula 6: Y₂O₃:Yb and Er

In this case, the luminescent material according to General Formula 1 is a luminescent material for emitting the light in the infrared wavelength range with respect to the incident light in the ultraviolet wavelength range, the luminescent material according to General Formula 2 is a luminescent material for emitting the light in the infrared wavelength range with respect to the incident light in the visible wavelength range, and the luminescent material according to General Formula 3 is a luminescent material for emitting the light in the infrared wavelength range with respect to the incident light in the ultraviolet or visible wavelength range. In addition, the luminescent materials according to General Formulas 4, 5, and 6 are up-conversion luminescent materials for emitting the light in the infrared and visible wavelength range with respect to the incident light in the infrared wavelength range.

In the embodiment of the present invention, the luminescent material 12 may be a material for emitting the light in the infrared wavelength range. The light in the infrared wavelength range cannot be detected with the naked eye, and thus whether the luminescent material 12 is included cannot be recognized without using an infrared detector. In addition, a large amount of light may be obtained by even a relatively small quantity of the luminescent material for emitting the infrared rays, and as a result, the luminescent material for emitting the infrared rays may be advantageous in terms of costs.

The luminescent material 12 in the form of a particle may be included in the base 11. In this case, an average particle size of the luminescent material 12 may be in a range of 0.3 to 10 and more particularly, a range of 0.5 to 5.0 If the particle size of the luminescent material is less than 0.3 the intensity of the emitted light is low, and the effect of the light is likely to deteriorate. If the particle size of the luminescent material is more than 10.0 the transparency of the base 11 may deteriorate.

The luminescent material 12 may be included at a ratio of 0.05 to 10 wt. % in the base 11. If the luminescent material 12 accounts for 0.05 wt. % or less, it is difficult to detect the light. If the luminescent material 12 accounts for 10 wt. % or more, transparency or chroma of the plastic product 1 may deteriorate. In the case of the plastic product 1 requiring transparency, the luminescent material 12 may be adjusted to be 1.0 wt. % or less.

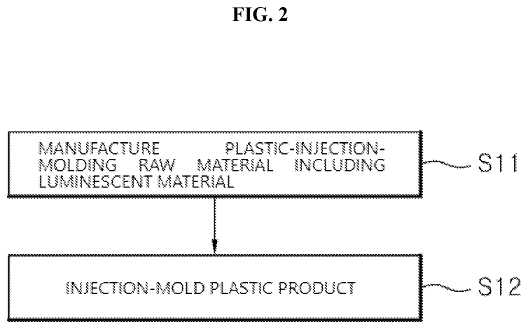

FIG. 2 is a flowchart for explaining a method of manufacturing the plastic product according to the embodiment of the present invention.

Referring to FIG. 2, the method of manufacturing the plastic product according to the embodiment of the present invention may include: a step S11 of manufacturing a plastic-injection-molding raw material including the luminescent material, and a step S12 of injection-molding the plastic product.

The step S11 of manufacturing the plastic-injection-molding raw material including the luminescent material may be a step of incorporating a raw material for injection molding into the luminescent material 12 when manufacturing a product in the form of a chip or the like. Specifically, the step S11 may be a step of manufacturing the injection-molding raw material by inputting the luminescent material 12 during a process of melting and extruding a polymeric material which is a raw material of the base 11 constituting the plastic product 1. In this case, if the luminescent material particles are agglomerated without being uniformly distributed in the polymeric material, the transparency of the plastic product 1 may deteriorate at least partially. Therefore, in order to inhibit the agglomeration, the surfaces of the luminescent material particles may be treated or coated with an organic material. In this case, the organic material with which the surfaces of the luminescent material particles are treated or coated may be at least one organic material selected from a group consisting of organic silicon compound, fatty acid-based compound such as fatty acid ester and fatty acid amide, and organic polymers or oligomers containing an alkoxy group, a maleic anhydride group, and an epoxy group.

The step S12 of injection-molding the plastic product is a step of injection-molding the plastic product using the raw material manufactured in the step S11. Specifically, the step S12 may be a step of heating and melting the injection-molding raw material and then injecting the melted injection-molding raw material into an injection mold using a piston. When the melted injection-molding raw material flows uniformly into the injection mold, the piston returns to the original position, and a molded product, which has been cooled and cured in the injection mold, may be separated from the injection mold.

The plastic product 1 according to the embodiment of the present invention, which is manufactured by the above-mentioned method, is manufactured in the state in which the luminescent material 12 is included in the base 11, and as a result, it is possible to determine the authenticity of the plastic product even in a case in which no separate security element is attached to the plastic product. In particular, whether the luminescent material 12 is included cannot be identified with the naked eye. Further, in a case in which the second wavelength is within an invisible region, whether the luminescent material 12 is included cannot be identified with the naked eye even though the plastic product is irradiated with the ultraviolet rays or the infrared rays. As a result, the plastic product is excellent in security. In addition, because a security element, which is identified with the naked eye, is not used, the design of the product is not affected by the security element.

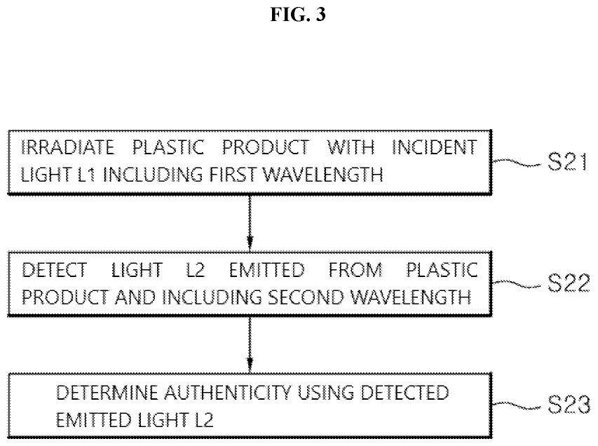

FIG. 3 is a flowchart for explaining a method of determining authenticity of the plastic product according to the embodiment of the present invention.

Referring to FIG. 3, the method of determining the authenticity of the plastic product according to the embodiment of the present invention includes: irradiating the plastic product, which is to be subjected to the authenticity determination, with the incident light L1 including the first wavelength (step S21); and detecting the emitted light L2 including the second wavelength and emitted from the plastic product (step S22). Further, the method includes determining the authenticity of the plastic product using the detected emitted light L2 (step S23).

The step S21 of irradiating the plastic product with the incident light L1 including the first wavelength is a step of irradiating the plastic product with the incident light that may excite the luminescent material 12 included in the base 11. For example, in the case in which the luminescent material 12 included in the base 11 is the luminescent material according to General Formula 1 that emits the light in the infrared wavelength range by the incident light in the ultraviolet wavelength range, the step S21 may be a step of irradiating the plastic product with the incident light L1 including the first wavelength in the ultraviolet wavelength range.

When the plastic product is irradiated with the incident light L1, the luminescent material 12 may be excited by the light including the first wavelength included in the incident light L1, thereby emitting the light L2 including the second wavelength. The step S22 is a step of detecting the emitted light L2. In the case in which the second wavelength is within the infrared wavelength range, the emitted light may be detected by an infrared detector such as an infrared sensor or an infrared camera.

Next, the authenticity is determined using the detected emitted light L2 (step S23). Prestored reference data may be used to determine the authenticity. In this case, the reference data may include peak values having specific wavelengths (the second wavelength). That is, when the peak having a predetermined size or more is detected in the second wavelength predetermined in the reference data, the plastic product may be determined as a genuine product. Alternatively, the reference data may be determined as a sum of intensity of the emitted light in the predetermined wavelength range including the second wavelength. That is, when a value made by integrating the intensity of the emitted light in the wavelength range predetermined in the reference data is a critical value or more, the plastic product may be determined as the genuine product. Alternatively, the reference data may be the light emitting lifetime of the emitted light. For example, the identification of the genuine product may be performed by comparing the reference data with a parameter in relation to the light emitting lifetime of the emitted light such as the decay time or the rate at which the intensity of the emitted light including the second wavelength decreases.

The first wavelength or the second wavelength may mean any one wavelength value or a predetermined wavelength range. In the step S22 or S23, a method of data-processing the spectrum of the emitted light and detecting the second wavelength in the spectrum and a method of detecting only the second wavelength using a filter for filtering out only the second wavelength may be used as the method of detecting the emitted light including the second wavelength. In this case, the filter may be a band-pass filter.

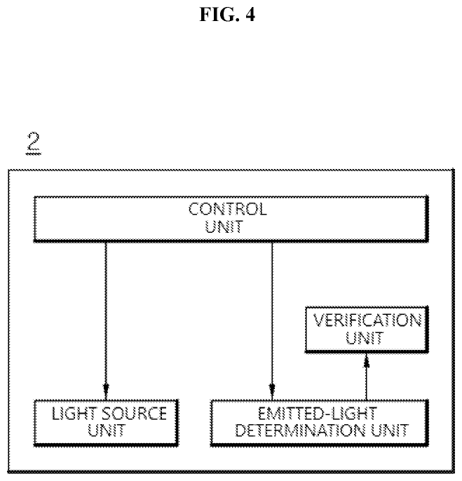

FIG. 4 is a schematic block diagram of an authenticity determination device capable of being used to perform the authenticity determination method illustrated in FIG. 3. Referring to FIG. 4, an authenticity determination device 2 according to the embodiment of the present invention may include a light source unit, an emitted-light determination unit, a verification unit, and a control unit.

The light source unit is configured to emit the incident light L1 including the first wavelength to the plastic product 1 and includes a light source capable of generating the light in the wavelength range including the first wavelength. For example, in the case in which the plastic product 1 includes the luminescent material according to General Formula 1 that emits the light in the infrared wavelength range with respect to the incident light in the ultraviolet wavelength range, the light source unit may include the light source, such as an ultraviolet lamp or a UV LED, capable of generating the ultraviolet rays.

The emitted-light determination unit is configured to detect the light L2 emitted from the plastic product 1 and may include an optical sensor capable of detecting the light having the second wavelength. For example, in the case of the light having the second wavelength in the infrared wavelength range, the emitted-light determination unit may include an infrared image capturing device such as an infrared sensor or an IR camera. Selectively, the emitted-light determination unit may have a filter that transmits only the light having the second wavelength.

The verification unit is configured to receive a detection result from the emitted-light determination unit and determine the authenticity of the plastic product. Specifically, the authenticity of the plastic product may be determined based on the predetermined reference data such as the wavelength of the emitted light, the height of the peak, the sum of the light emitting intensity in the predetermined wavelength range, and the decay time. The verification unit may include a memory for storing the reference data, and an arithmetic operation circuit for performing the comparison with the reference data.

The control unit is configured to control the operations of the functional blocks of the authenticity determination device 2. The control unit may control an ON/OFF operation of the light source unit and control the operation of detecting the emitted light by the emitted-light determination unit in conjunction with the ON/OFF operation of the light source unit. In addition, the control unit may receive the authenticity determination result from the verification unit and control an additional operation of displaying a verification result through a non-illustrated display unit.

The authenticity determination device 2 may be manufactured as a separate independent device or mounted or embedded in a mobile device such as a smartphone or a tablet PC. The authenticity determination device 2 may have a communication unit to transmit the verification result from the verification unit to a separate server. Alternatively, the detection data from the emitted-light determination unit may be transmitted to the server so that the server performs the verification operation. FIG. 4 illustrates the verification unit and the control unit as separate blocks, but the verification unit may be embedded in the control unit such that the control unit may perform the verification.

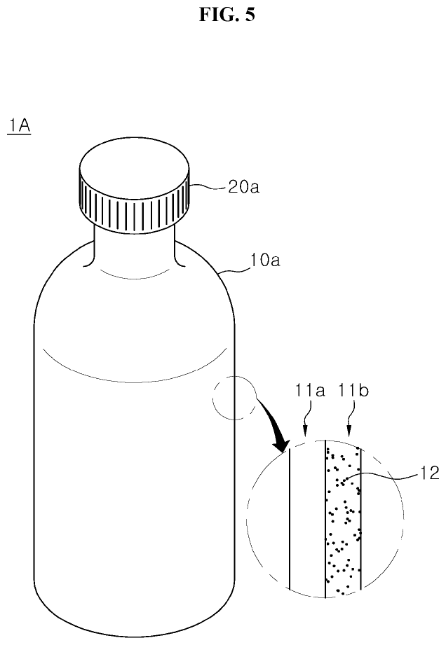

FIGS. 5 to 7 are views schematically illustrating plastic products according to other embodiments of the present invention.

First, a plastic product 1A according to an embodiment illustrated in FIG. 5 is different from the plastic product according to the embodiment illustrated in FIG. 1 in that the base has a plurality of layers, and only some of the plurality of layers include the luminescent material.

For example, the plastic product 1A may have a dual structure including a first base 11a and a second base 11b, and only the second base 11b may include the luminescent material 12.

The structure illustrated in FIG. 5 may be molded by a dual injection process or a co-injection process. That is, a process of injection-molding the first base 11a using an injection-molding raw material including no luminescent material and a process of injection-molding the second base 11b using an injection-molding raw material including the luminescent material may be sequentially or simultaneously performed. However, the present invention is not limited to the configuration in which the structure illustrated in FIG. 5 is manufactured by the injection-molding process, the structure may be manufactured by various processes capable of forming the base having the plurality of layers. For example, the second base 11b including the luminescent material may be printed or applied onto a surface of the first base 11a including no luminescent material.

FIG. 5 illustrates the dual structure including the first base 11a and the second base 11b, but the present invention is not limited thereto. For example, a layer including no luminescent material may be additionally provided outside the second base 11b or between the first base 11a and the second base 11b. In addition, the plastic materials, which are raw materials of the first base 11a and the second base 11b, may be identical to or different from each other.

The configuration in which only some layers of the base of the plastic product include the luminescent material 12 as illustrated in FIG. 5 may have the following advantageous effects.

First, in the case in which the entire plastic product includes the luminescent material 12, the result detected by the emitted-light determination unit may vary depending on the thickness of the product. In contrast, in the case in which the luminescent material 12 is included only in the second base 11b having a constant thickness, the result detected by the emitted-light determination unit does not vary depending on the thickness of the product. That is, the authenticity determination device 2 illustrated in FIG. 4 determines the authenticity by comparing the result of detecting the emitted light with the prestored reference data. In this case, when the thickness of the product increases, the quantity of the luminescent material 12 increases in a direction of the thickness of the product, which may cause a change in detection result, such as an increase in peak value of the second wavelength. This may cause discomfort because different reference data need to be used in accordance with types of products when the peak values are used as the reference data.

In contrast, in the case in which the thickness of the base including the luminescent material 12 is constant regardless of the overall thickness of the product, the quantity of the luminescent material 12 is constant in the direction of the thickness of the product even though the overall thickness of the product varies depending on types of products, and as a result, the same reference data may be applied.

In addition, the configuration in which the luminescent material 12 is included only in a part of the overall thickness of the base is advantageous in terms of manufacturing costs because it is not necessary to provide the expensive luminescent material to the entire product.

In particular, in the case in which the plastic product 1A is a plastic container for accommodating food, drink, medicines, cosmetics, or the like, the luminescent material is not included in the first base 11a which is disposed inside the plastic container and in contact with the contents in the container, and the luminescent material 12 is included only in the second base 11b which is disposed outside the plastic container. As a result, it is possible to basically inhibit the contents in the container from being contaminated by the luminescent material 12.

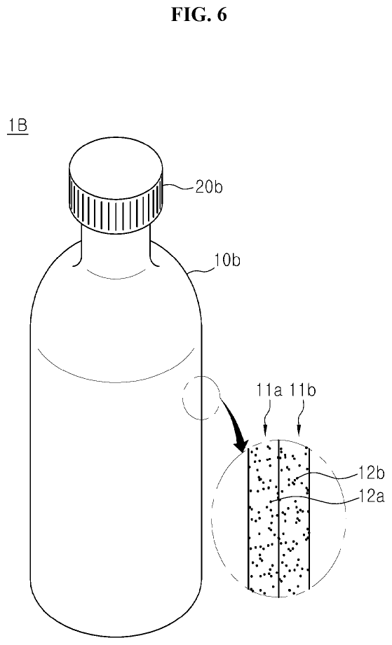

A plastic product 1B according to an embodiment illustrated in FIG. 6 is different from the plastic product according to the embodiment illustrated in FIG. 5 in that different luminescent materials are included in the first base 11a and the second base 11b.

Referring to FIG. 6, the plastic product 1B includes a first base 11a and a second base 11b. The first base 11a includes a first luminescent material 12a, and the second base 11b includes a second luminescent material 12b. In this case, the first luminescent material 12a and the second luminescent material 12b are different from each other.

The first luminescent material 12a and the second luminescent material 12b may emit light by being excited by different types of incident light or emit light by being excited by the same type of incident light. The first luminescent material 12a and the second luminescent material 12b may emit different types of light having different wavelengths or the same type of light having the same wavelength. In addition, the light emitted from the first luminescent material 12a and the light emitted from the second luminescent material 12b may have different light emitting lifetime characteristics. That is, the first luminescent material 12a and the second luminescent material 12b may be made of different materials which are different in at least one of the excitation light and the emitted light.

Since the plastic product 1B according to the embodiment illustrated in FIG. 6 includes the different luminescent materials 12a and 12b, the reference for determining the authenticity becomes stricter, such that the security may be further improved. For example, when a wavelength of the light emitted from the first luminescent material 12a is referred to as a second-a wavelength and a wavelength of the light emitted from the second luminescent material 12b is referred to as a second-b wavelength, the plastic product may be determined as a genuine product when both the second-a wavelength and the second-b wavelength are detected, and the plastic product may be determined as a counterfeit product when even any one of the second-a wavelength and the second-b wavelength is not detected. Alternatively, in the case in which the decay time of the emitted light is used as the reference data, the plastic product may be determined as a genuine product only when the decay time of the second-a wavelength and the decay time of the second-b wavelength may satisfy a verification reference. In this case, the second-a wavelength and the second-b wavelength may be equal to each other.

FIG. 6 illustrates the first base 11a and the second base 11b disposed as different layers. However, in some instances, the first luminescent material 12a and the second luminescent material 12b may be dispersed into a single base, thereby obtaining the effect of improving the security.

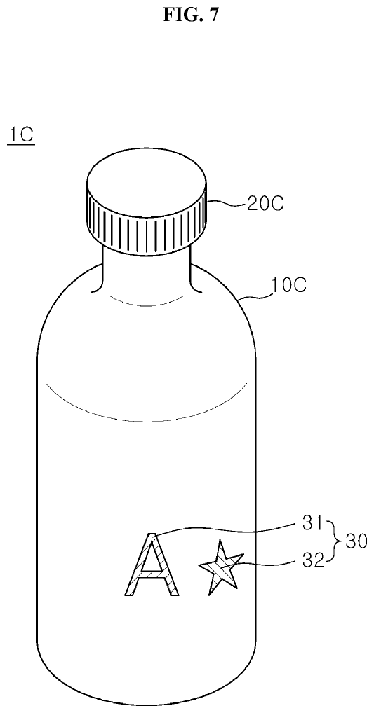

A plastic product 1C according to an embodiment illustrated in FIG. 7 may include marks 30 printed on a surface of the product using ink including the luminescent material. That is, in the above-mentioned embodiments, the luminescent material is included in the base constituting the plastic product 1C. However, according to the embodiment illustrated in FIG. 7, the luminescent material (not illustrated) is included in the ink used to print the marks 30 on the surface of the plastic product 1C. The mark 30 may be a letter 31 or a pattern 32 for expressing a product brand or a logo.

The luminescent material included in the ink may be an invisible material, and as a result, the authenticity may be determined using the method illustrated in FIG. 3. In this case, the authenticity may be determined by irradiating the mark 30 with the incident light L1 and detecting the emitted light L2 from the mark 30. The plastic product 1C according to the present embodiment also makes it difficult to recognize whether the security element is applied to the mark 30 in a visible light environment, and as a result, the plastic product 1C is excellent in security.

The embodiment illustrated in FIG. 7 may be combined with other embodiments and carried out. For example, the luminescent material may be included in the base, and the different luminescent materials may be included in the ink used to print the mark 30. Therefore, it is possible to further improve the security.

The plastic containers have been described as examples with reference to FIGS. 1 to 7, but the descriptions are illustrative, and the plastic product according to the present invention is not limited to the plastic container. For example, the plastic product according to the present invention may include an engineering plastic product. The engineering plastic product may include a base, and a luminescent material included in the base. The engineering plastic product may be provided in the form of a film. In this case, a material of the base of the engineering plastic film may be a material including polyamide, polyacetyl, polycarbonate, polyester resin (PBT), modified polyphenylene oxide (PPO), or fiber reinforced plastic (FRP) in which fiberglass or carbon fiber is mixed. The engineering plastic product may be manufactured by extruding an engineering-plastic raw material into which the luminescent material is uniformly dispersed.

In a case in which the engineering plastic product has a multilayer structure, the engineering plastic product may be manufactured by coextrusion or various manufacturing methods. In the case in which the engineering plastic product has the multilayer structure, the luminescent material may be included in an uppermost layer of the multilayer structure, an intermediate layer of the multilayer structure, or a lowermost layer of the multilayer structure. Because the intensity may decrease when the light emitted from the luminescent material passes through the base, it may be advantageous to provide the luminescent material in the uppermost layer in terms of optical sensitivity of the emitted-light determination unit.

The limited embodiments have been described above with reference to the drawings, but the embodiments are merely illustrative, and it is apparent to those skilled in the art that the embodiments may be variously modified without departing from the technical scope of the present invention. For example, some or all of the embodiments may be selectively combined and carried out. In addition, the present invention may be applied to various plastic products such as a casino chip and a casing for an electronic product such as a mobile phone which are at least partially made of plastic, in addition to the plastic container or the engineering plastic product. In addition, the luminescent material may be contained in the entire plastic product or contained in any one portion of the plastic product. Therefore, the protection scope of the present invention should be defined by the appended claims and the equivalents of the claims.

1. A plastic product with authenticity to be determined, the plastic product comprising:
a base made of a plastic material; and
a luminescent material included in the base and configured to absorb incident light of a first wavelength and emit light of a second wavelength,
wherein the determination of the authenticity is performed by irradiating the plastic product with the incident light and then detecting the emitted light.

2. The plastic product of claim 1,
wherein the base comprises a plurality of layers, and the luminescent material is included only in some of the plurality of layers.

3. The plastic product of claim 1,
wherein the base comprises a plurality of layers, and the plurality of layers includes different luminescent materials.

4. The plastic product of claim 3,
wherein the different luminescent materials are different in at least one of excitation light and emitted light.

5. The plastic product of claim 1,
wherein the plastic product is manufactured by an injection molding process or an extrusion process.

6. The plastic product of claim 1,
wherein the base comprises a plurality of layers, and the plastic product is manufactured by a dual injection molding process, a co-injection molding process, or a coextrusion process.

7. The plastic product of claim 1,
wherein the second wavelength is in an infrared wavelength range.

8. The plastic product of claim 1,
wherein the luminescent material is at least any one of materials according to the following General Formulas 1 to 6,
General Formula 1: Ba₁₋ₓSnAₓO₃ (0<x<0.4, and A represents Li or Na);
General Formula 2: CaMoO₄:M (M represents one or two or more lanthanide metal ions selected from a group consisting of Nd³⁺, Yb³⁺, and Er³⁺);
General Formula 3: Y₂SiV₂O₁₀: Nd³⁺ and Er³⁺,
General Formula 4: Y₂O₃:Yb and Ho;
General Formula 5: Y₂O₃:Yb and Tm; and
General Formula 6: Y₂O₃:Yb and Er.

9. The plastic product of claim 1,
wherein the luminescent material is provided in the form of a particle and included in the base, and an average particle size of the luminescent material is in a range of 0.3 μm to 10 μm.

10. The plastic product of claim 1,
wherein the luminescent material is provided in the form of a particle and included in the base, and a surface of the luminescent material particle is treated or coated with an organic material.

11. The plastic product of claim 1,
wherein the plastic product is any one of a plastic container, an engineering plastic product, a plastic film, a casino chip, and an electronic product casing.

12. The plastic product of claim 2,
wherein the plastic product is a plastic container comprising an accommodation part having an accommodation space for accommodating contents, the base comprises a first base provided inside the plastic container and disposed adjacent to the accommodation space, and a second base provided outside the first base, and the luminescent material is included only in the second base without being included in the first base.

13. A method of determining authenticity of a plastic product, the method comprising:
a step (a) of irradiating the plastic product with first light of a first wavelength;
a step (b) of detecting a second light of a second wavelength emitted from the plastic product; and
a step (c) of determining authenticity using the detected emitted light.

14. The method of claim 13,
wherein the step (c) comprises a step of comparing a preset critical value with a peak value of the second wavelength, a sum of intensity of emitted light in a predetermined wavelength range including the second wavelength (a value made by integrating intensity of the emitted light in a predetermined wavelength range), or a light emitting lifetime of the second wavelength.

15. An authenticity determination device for determining authenticity of a plastic product, the authenticity determination device comprising:
a light source unit configured to emit first light of a first wavelength toward the plastic product;
an emitted-light determination unit configured to detect second light of a second wavelength emitted from the plastic product which is irradiated with the first light; and
a verification unit configured to receive a detection result from the emitted-light determination unit and determine the authenticity of the plastic product.

16. A plastic product with authenticity to be determined, the plastic product comprising:
a base having a surface on which a mark is printed; and
a luminescent material included in the mark and configured to emit light including a second wavelength with respect to incident light including a first wavelength,
wherein the determination of the authenticity is performed by irradiating the mark with the incident light and then detecting the emitted light.
